(19) United States
(12) Patent Application Publication
(10) Pub. No.: US 2025/0276605 A1
(43) Pub. Date: Sep. 4, 2025

(54) CONTROLLER FOR REPLACEABLE BATTERIES

(71) Applicant: TOYOTA JIDOSHA KABUSHIKI KAISHA, Toyota-shi (JP)

(72) Inventor: Toshihiro NAKAMURA, Sunto-gun (JP)

(73) Assignee: TOYOTA JIDOSHA KABUSHIKI KAISHA, Toyota-shi (JP)

(21) Appl. No.: 19/004,570

(22) Filed: Dec. 30, 2024

(30) Foreign Application Priority Data
Feb. 29, 2024 (JP) 2024-030478

(51) Int. Cl. B60L 53/80; B60L 53/66

(52) U.S. Cl. CPC B60L 53/80; B60L 53/66; B60L 2260/54

(57) ABSTRACT

A controller for a plurality of replaceable batteries includes a controller for varying an overall battery capacity by connecting the exchangeable batteries in parallel in a vehicle mounting the exchangeable batteries. Further, the controller acquires, from a replacement battery station, information including at least remaining amounts of the replaceable batteries that the replacement battery station has, calculates consumed SOC when the vehicle travels from a current position of the vehicle to the replacement battery station based on the current position of the vehicle and a position of the replacement battery station, determines a replacement number and a target SOC of the replaceable batteries based on the calculated consumed SOC, remaining amounts of the replaceable batteries in the replacement battery station, and remaining amounts of the replaceable batteries mounted on the vehicle, and control the replaceable batteries to satisfy the determined replacement number and the target SOC.

### CROSS-REFERENCE TO RELATED APPLICATION(S)

The present application claims priority to and incorporates by reference the entire contents of Japanese Patent Application No. 2024-030478 filed in Japan on Feb. 29, 2024.

### BACKGROUND

The present disclosure relates to a controller for replaceable batteries.

Japanese Laid-open Patent Publication No. 2022-174873 discloses a technique in which in an electric vehicle in which a plurality of replaceable batteries is mounted, a predicted value of the power required to travel on the travel route and a predicted value of the battery remaining amount of the starting point of the travel route are calculated for determining the replacement number of the battery based on these predicted values.

### SUMMARY

There is a need for providing a controller for replaceable batteries capable of ensuring the necessary and sufficient battery capacity in the entire vehicle.

According to an embodiment, a controller for a plurality of replaceable batteries includes a controller for varying an overall battery capacity by connecting the exchangeable batteries in parallel in a vehicle mounting the exchangeable batteries. Further, the controller acquires, from a replacement battery station, information including at least remaining amounts of the replaceable batteries that the replacement battery station has, calculates consumed SOC when the vehicle travels from a current position of the vehicle to the replacement battery station based on the current position of the vehicle and a position of the replacement battery station, determines a replacement number and a target SOC of the replaceable batteries based on the calculated consumed SOC, remaining amounts of the replaceable batteries in the replacement battery station, and remaining amounts of the replaceable batteries mounted on the vehicle, and control the replaceable batteries to satisfy the determined replacement number and the target SOC.

### BRIEF DESCRIPTION OF THE DRAWINGS

FIG. 1 is a block diagram illustrating a schematic configuration of a vehicle including a controller for replaceable batteries according to an embodiment, a replacement battery station, and a cloud server;

FIG. 2 is a block diagram illustrating a configuration of a controller of the vehicle constituting the controller for the replaceable batteries according to the embodiment;

FIG. 3 is a schematic diagram illustrating a first example of control of replaceable batteries performed by the controller of the replaceable batteries according to an embodiment;

FIG. 4 is a schematic diagram illustrating a second example of control of replaceable batteries performed by the controller of the replaceable batteries according to an embodiment; and

FIG. 5 is a flowchart illustrating a flow of a method of controlling a replaceable battery that is performed by the controller of the replaceable batteries according to the embodiment.

### DETAILED DESCRIPTION

In the electric vehicle disclosed in Japanese Laid-open Patent Publication No. 2022-174873, the replaceable battery is provided for each drive wheel, since the battery capacity of the replaceable battery for each of the drive wheels is controlled. Therefore, there is a possibility that excess or deficiency of power when viewed in the entire vehicle occurs.

A controller for replaceable batteries according to an embodiment of the present disclosure will be described with reference to the accompanying drawings. In addition, components in the following embodiments include those which can be substituted and easily by those skilled in the art, or those which are substantially the same.

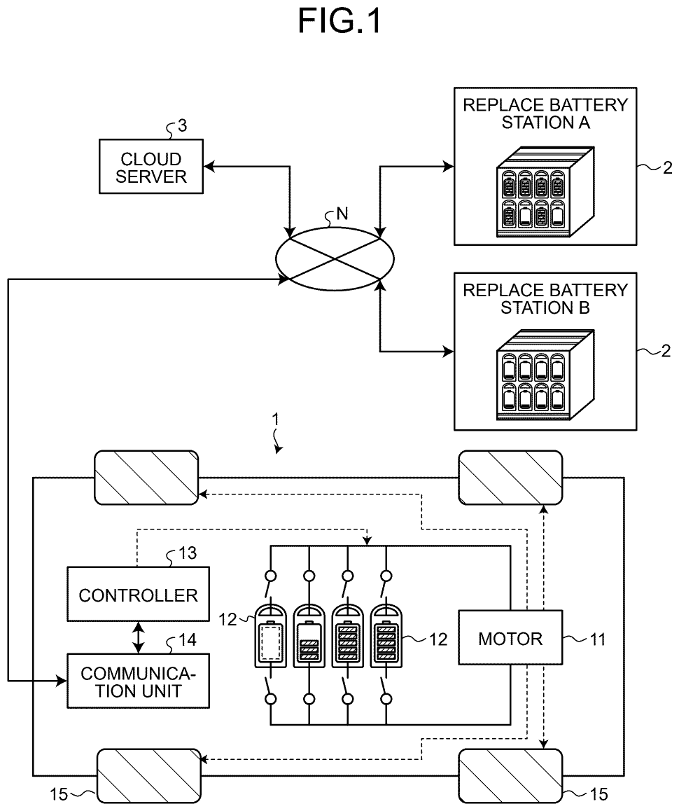

Controllers for replaceable batteries A controller for replaceable batteries (interchangeable batteries) according to an embodiment will be described with reference to FIGS. 1 to 4. The controller of the replaceable batteries according to the embodiment is for controlling a plurality of replaceable batteries mounted on a vehicle. Herein, the terms “controlling a plurality of replaceable batteries” includes, for example, which of a plurality of replaceable batteries is to be used first, what level of remaining amounts of replaceable batteries (remaining battery) to be used, and the like.

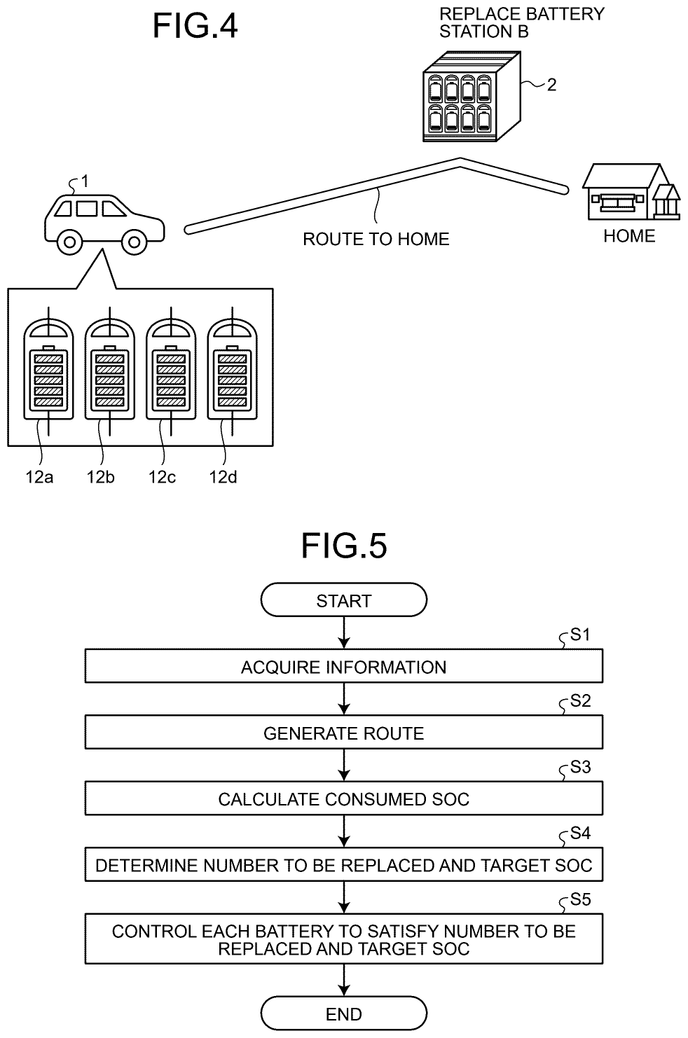

The controller for replaceable batteries according to the embodiment is mounted on a vehicle 1 as illustrated in FIG. 1. The vehicle 1 is, for example, a Plug-in Hybrid Electric Vehicle (PHEV), an Battery Electric Vehicle (BEV). In addition, the vehicle 1 is configured to communicate with the replacement battery station 2 and a cloud server 3 through the network N so as to exchange various types of information. The network N is composed of, for example, the Internet network, a mobile phone line network or the like. In the present embodiment, the replacement battery station 2 is sometimes referred to as “replacement battery station A” or “replacement battery station B” (see FIGS. 3 and 4).

The vehicle 1 includes a motor 11, a plurality of replaceable batteries (battery pack) 12, a controller 13, a communication unit 14, and wheels (drive wheels) 15. Note that, in FIG. 1, among the configurations of the vehicle 1, only the configurations for realizing the function of the control device of the replaceable battery according to the embodiment are illustrated, and other configurations are not illustrated. Further, among the configuration of the vehicle 1, the controller 13 functions as a controller for the replaceable batteries.

The motor 11 is a driving source of the vehicle 1. The motor 11 is operated by power supplied from an replaceable battery 12 to drive each wheel 15.

The replaceable battery 12 is a battery pack such as, for example, a lithium ion battery. There is a plurality of replaceable batteries 12 mounted in the vehicle 1, to supply power to the motor 11. Further, under control of the controller 13 described later, the replaceable batteries 12 are connected in parallel as necessary. Thus, by a part or all the replaceable batteries 12 connected in parallel, the overall battery capacity is variable. To realize the part or all of the replaceable batteries 12 connected in parallel as one battery, for example, a relay, a transistor, a step-up converter or the like is used.

The replaceable batteries 12 each has a power performance required to drive the vehicle 1. That is, a single replaceable battery 12 is not provided to support for driving only a single wheel 15, but each of the replaceable batteries 12 alone has the ability to drive all of the wheels 15. For example, as illustrated in FIG. 1, four replaceable batteries 12 are mounted on a vehicle 1, and if the respective replaceable batteries 12 have a 15 kWh capacity, they can be considered as a total 60 kWh capacity battery. In the present embodiment, the replaceable batteries 12 may be referred to as “replaceable batteries 12a, 12b, 12c, 12d” (see FIGS. 3 and 4).

The controller 13 is an Electronic Control Unit (ECU) having, as main component parts, a Central Processing Unit CPU, a Read Only Memory (ROM), and a Random Access Memory (RAM) or the like. The controller 13 comprehensively controls the operation of the various components of the vehicle 1 by executing various programs.

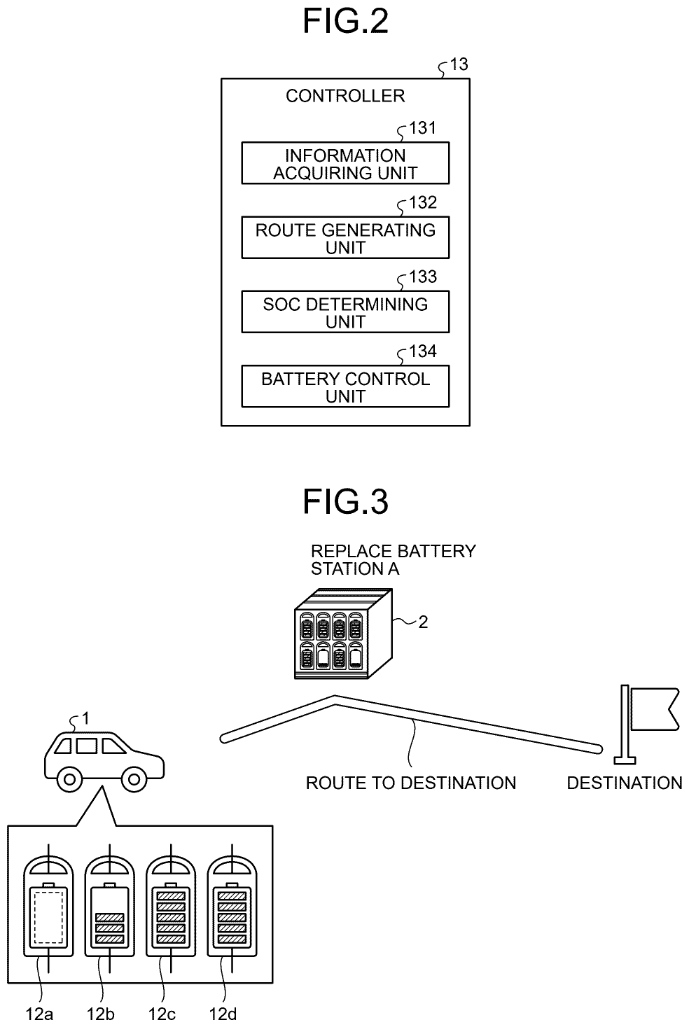

In the vehicle 1 mounting a plurality of the exchangeable batteries 12, the controller 13 cuts the connections of the plurality of exchangeable batteries 12 connected in parallel or in series to vary the overall battery capacity. Further, as indicated in FIG. 2, the controller 13 specifically functions as an information acquiring unit 131, a route generating unit 132, an SOC determining unit 133, and a battery control unit 134.

The information acquiring unit 131 acquires information including at least the remaining amount of the replaceable battery 12 possessed by the replacement battery station 2 from the replacement battery station 2. The information that the information acquiring unit 131 acquires from the replacement battery station 2 includes, for example, the following.
(1) The number of replaceable batteries 12 that can be replaced by the replacement battery station 2 (hereinafter referred to as “the number of replaceable batteries”);
(2) A remaining amount of the replaceable battery 12 that can be replaced by the replacement battery station 2 (hereinafter referred to as “the remaining Replaceable Battery Amount”);
(3) The number of replaceable batteries 12 that the replacement battery station 2 wants to replace (hereinafter referred to as “number of batteries that should be replaced”);
(4) A remaining amount of the replaceable battery 12 that the replacement battery station 2 wants to replace (hereinafter referred to as “Remaining Required Battery Amount”);
(5) The number of replaceable batteries 12 other than the replaceable batteries 12 that the replacement battery station 2 wants to replace;
(6) A remaining capacity of the replaceable battery 12 other than the replaceable battery 12 that the replacement battery station 2 wants to replace; and
(7) Location information of the replacement battery station 2.

The information acquiring unit 131 may acquire the information of the above-described (1) to (7) not from the replacement battery station 2 but via the cloud server 3. In this case, the information of the above-described (1) to (7) is previously transmitted from the replacement battery station 2 to the cloud server 3.

The information acquiring unit 131 acquires information required for calculation of a consumed SOC (consumption SOC) in the SOC determining unit 133 from an external roadway information server or the like. As the information which the information acquisition part 131 acquires from the road information server, for example, information on the slope of the road, the speed limit, and the vehicle speed when the vehicle 1 travels in the past on the route generated by the route generation part 132 (hereinafter, referred to as “road information”) or the like can be exemplified. The information acquiring unit 131 may acquire the road information via the cloud server 3. In this case, the road information is transmitted in advance from the road information server to the cloud server 3.

The route generating unit 132 generates a route (traveling route) on which the vehicle 1 travels. The route created by the route generating unit 132 includes, for example, a route in the case of traveling from the current position of the vehicle 1 to the replacement battery station 2, a route in the case of traveling from the current position of the vehicle 1 to a predetermined destination via the replacement battery station 2, and the like. The present position of the vehicle 1 can be obtained by, for example, a Global Positioning System (GPS) (not shown) positioning device or the like mounted on the vehicle 1. The replacement battery station 2 included on the route may be specified on the vehicle 1 side, or the replacement battery station 2 existing near the route to the destination may be automatically selected.

For example, when the vehicle 1 previously possesses the position information of the replacement battery station 2, the route generating unit 132 generates the route based on the position information of the replacement battery station 2 possessed and the current position of the vehicle 1. In addition, for example, when the vehicle 1 acquires the positional information of the replacement battery station 2 from the replacement battery station 2, the route generating unit 132 generates the above-described route based on the acquired positional information of the replacement battery station 2 and the current position of the vehicle 1.

The SOC determination unit 133 determines a target SOC of the replaceable batteries 12 mounted on the vehicles 1. First, the SOC determination unit 133 calculates a consumed SOC when traveling from the current position of the vehicle 1 to the replacement battery station 2 based on the current position of the vehicle 1 and the position of the replacement battery station 2 on the route generated by the route generating unit 132. In the calculation of the consumed SOC, the roadway information on the route generated by the route generating unit 132, information on the dimensions of the vehicle 1 (for example, electric power cost), or the like may be considered.

Subsequently, the SOC determination unit 133 determines the replacement number of the replaceable battery 12 that the vehicle 1 exchanges at the replacement battery station 2 from the calculated consumed SOC, the remaining amount of the replaceable battery 12 possessed by the replacement battery station 2, and the remaining amount of the replaceable battery 12 mounted on the vehicle 1. At the same time, the SOC determining section 133 determines the target SOC of the replaceable batteries 12 mounted on the vehicles 1.

The battery control unit 134 controls the replaceable batteries 12 mounted on the vehicle 1. The battery control unit 134, so as to satisfy the replacement number and the target SOC of the replaceable batteries 12 determined by the SOC determination unit 133, controls the respective replaceable batteries 12. Hereinafter, an example of the control of the replaceable batteries 12 by the battery control unit 134 will be described with reference to FIGS. 3 and 4.

FIG. 3 is a diagram for explaining a first embodiment of control of replaceable batteries 12 (12a, 12b, 12c, 12d) by a battery control unit 134. In this example, it is assumed that in order for the vehicle 1 to arrive at a destination, when it is necessary to replace the replaceable batteries 12 in the way, and the replacement battery station A on the route, when the replacement batteries 12 with a large remaining amount is sufficiently stocked. Further, “when it is necessary to replace the replaceable batteries 12 in the way” refers to a case that cannot reach the destination even if consumes all the remaining amount of the replaceable batteries 12 of the vehicle 1.

In this case, first, the route generating unit 132 generates a route that travels from the current position of the vehicle 1 to the destination via the replacement battery station A. Subsequently, the SOC determining unit 133 calculates the consumed SOC when the vehicle travels from the present position of the vehicle 1 to the replacement battery station A.

Subsequently, the SOC determination unit 133 determines the number of replaceable batteries 12 to be replaced based on, for example, SOC consumed from the present position to the replacement battery station A, the remaining amount of the replaceable batteries 12 of the replacement battery station A, the remaining amount of the replaceable batteries 12 of the vehicles 1. At the same time, the SOC determining section 133 determines the target SOC of the replaceable batteries 12 of the vehicles 1.

Then, the battery control unit 134, so as to satisfy the replacement number and target SOC of the determined replaceable battery 12, controls the respective replaceable battery 12. For example, as illustrated in FIG. 3, consider the case where the remaining amount of the replaceable battery 12a is 0%, the remaining amount of the replaceable battery 12b is 60%, and the remaining amount of the replaceable battery 12c and 12d is 100% at the present position of the car 1. Further, in the SOC determining unit 133, consider the cases where it is determined that the replacement number of the replaceable battery 12: two (replace the replaceable battery 12a and 12b), the target SOC: 100% of the replaceable battery 12c and 12d (to maintain the full).”

In this instance, the battery control unit 134, when driving the motor 11, uses the replaceable battery 12b remaining 60%, so that the replacement number does not increase. At the same time, the battery control unit 134 only uses the replaceable battery 12b in order to maintain 100% of the remaining capacity of the replaceable batteries 12c and 12d. Herein, it is assumed that not only the replaceable battery 12a remaining amount 0% but also the replaceable battery 12b remaining amount 60% are replaced. However, only the replaceable battery 12a remaining amount 0% may be replaced. Further, it may be adjusted as appropriate in view of a labor of the replacement on a side of the vehicle 1.

FIG. 4 is a diagram for explaining a second embodiment of control of a replaceable battery 12 (12a, 12b, 12c, 12d) by the battery control unit 134. In this example, it is assumed that in order for the vehicle 1 to arrive at home (destination), a case having a sufficient remaining amount, and the remaining amount of the replaceable battery 12 that is stocked in the replacement battery station B on the route is small. In this case, the vehicle 1 from the replacement battery station B, information about the number of replacement desired batteries and the replacement desired battery remaining amount are transmitted. Therefore, a situation is that the replacement of the replaceable battery 12 is required.

In this case, first, the route generating unit 132 generates a route that travels from the current position of the vehicle 1 to the home via the replacement battery station B. Subsequently, the SOC determination unit 133 calculates the consumption SOC when the vehicle travels from the present position of the vehicle 1 to the replacement battery station B and the consumption SOC when the vehicle 1 travels from the replacement battery station B to the home.

Subsequently, the SOC determination unit 133 determine the replacement number of the replaceable battery 12 based on, for example, the consumption SOC from the present position to the replacement battery station B, the consumption SOC from the replacement battery station B to home, the remaining amount of the replaceable battery 12 of the replacement battery station B, the remaining amount of the replaceable battery 12 of the vehicle 1. At the same time, the SOC determining section 133 determines the target SOC of the replaceable batteries 12 of the vehicles 1.

Then, the battery control unit 134, so as to satisfy the replacement number and target SOC of the determined replaceable battery 12, controls each of the replaceable batteries 12. For example, as illustrated in FIG. 4, a case is considered where the remaining capacity of the replaceable batteries 12a, 12b, 12c, 12d is 100% at the present position of the vehicle 1. Further, in the SOC determining unit 133, a case is considered where it is determined that “the replacement number of the replaceable batteries 12 is three (replace any three of the replaceable batteries 12a, 12b, 12c, 12d)”, and “the target SOC: 100% of the replaceable batteries 12a, 12b, 12c, 12d (to maintain the full)”.

In this instance, the battery control unit 134, when driving the motor 11, uses only one of the replaceable batteries 12a, 12b, 12c, 12d, so that the number of replacements is not reduced. At the same time, the battery control unit 134 may use only any one of the replaceable batteries 12a, 12b, 12c, 12d to maintain the remaining 100% of any three of the replaceable batteries 12a, 12b, 12c, 12d. Incidentally, as in the present example, in a case where the replaceable battery 12 is delivered from the vehicle 1 to the replacement battery station B, when delivering the replaceable battery 12 with a large remaining amount, it may be considered that a contract or the like between the operator of the replacement battery station B is made and it may be given incentives to the user of the vehicle 1.

Here, the control of the replaceable battery 12 by the battery control unit 134 is not limited to the examples illustrated in FIGS. 3 and 4. For example, in FIG. 3, in the current position of the vehicle 1, the replacement battery 12 is sufficiently stored in the replacement battery station A, but when the vehicle 1 arrives at the replacement battery station A, it is also assumed that the replacement battery 12 has already been replaced by another vehicle. In this case, even if the vehicle 1 arrives at the replacement battery station A, there is a possibility that it is impossible to replace the replacement battery 12 of the desired number.

Accordingly, the replacement battery station A may transmit information about the number of replaceable batteries and the remaining amounts of replaceable batteries to the vehicle 1 each time a change occurs in the number of replaceable batteries 12 to be held and the remaining amounts of replaceable batteries. In response, the vehicle 1 can exchange the replaceable battery 12, for example, by accessing another replacement battery station located near the route.

Further, for example, in FIG. 4, in the current position of the vehicle 1, the remaining amount of the replaceable battery 12 that is stocked in the replacement battery station B is small. But when the vehicle 1 arrives at the replacement battery station B, it is also assumed that the replacement battery 12 has already been replaced by another vehicle. In this case, even if the vehicle 1 arrives at the replacement battery station B, replacement of the replaceable battery 12 is not required, so that the travel to the battery station B is wasted time.

Therefore, whenever a change occurs in the replacement desired battery number and the replacement desired battery remaining amount of the replaceable battery 12 possessed, the replacement battery station B may transmit to the vehicle 1 the information about the replacement desired battery number and the replacement desired battery remaining amount. In response to this, the vehicle 1 can perform replacement of the replaceable battery 12, for example, by traveling to home without replacing the replaceable battery 12, or by accessing another replacement battery station located near the route.

The communication unit 14 is composed of, for example, a Data Communication Module (DCM) or the like. The communication unit 14 exchanges information with the replacement battery station 2 and the cloud server 3 through communication through the network N.

The replacement battery station 2 is a base having a plurality of replaceable batteries 12. The replaceable batteries 12 possessed by the replacement battery station 2 are the same replaceable batteries 12 that is mounted on the vehicle 1. The replacement battery station 2 performs replacement of the replaceable batteries 12 with the vehicle 1 based on a request from the vehicle 1 side or a request from the replacement battery station 2 side.

For example, in the case of a request on the side of the vehicle 1, the replacement battery station 2 receives from the vehicle 1 a replacement battery 12 that has a reduced remaining capacity or remaining 0%, and delivers to the vehicle 1 a replacement battery 12 with a remaining capacity of 100% (full) in exchange for it (see FIG. 3). Also, for example, in the case of a request on the side of the replacement battery station 2, the replacement battery station 2 delivers to the vehicle 1 a replacement battery 12 of 0% remaining or reduced remaining, and receives from the vehicle 1 a replacement battery 12 of 100% remaining (see FIG. 4). Incidentally, in the present embodiment describes an example in the case of exchanging information and exchangeable battery 12 between the replacement battery station 2 and one vehicle 1, but actually exchange information and exchangeable battery 12 between the replacement battery station 2 and an unspecified number of vehicles.

The cloud server 3 is realized by a general-purpose computer such as a workstation or a personal computer. The cloud server 3 transmits the information of the above-mentioned (1) to (7) previously acquired from the replacement battery station 2 to the vehicle 1 as needed.

The cloud server 3 may be responsible for a part of the function of the controller 13 of the vehicle 1. The cloud server 3 may perform the functions of the route generating unit 132 and the SOC determining unit 133 among the functions of the controller 13, for example. Thus, it is possible to reduce the calculation load of the controller 13 of the vehicle 1.

### How to Control the Replaceable Battery

The flow of the control method of the replaceable battery according to the embodiment will be described with reference to FIG. 5.

First, the information acquiring unit 131 acquires information including at least the remaining amount of the replaceable batteries 12 possessed by the replaceable battery station 2 from the replaceable battery station 2 (step S1). Subsequently, the route generating unit 132 generates the route including at least the route from the present position of the vehicle 1 to the replacement battery station 2 based on the information acquired in the step S1 (step S2).

Subsequently, the SOC determination unit 133 calculates the consumed SOC when the vehicle 1 travels from the present position to the replacement battery station 2 from the present position of the vehicle 1 based on the position of the replacement battery station 2 on the route generated by the route generating unit 132 (step S3). Subsequently, the SOC determination unit 133 determines the replacement number of the replaceable batteries 12 to be replaced by the vehicle 1 at the replacement battery station 2 and the target SOC of the respective replaceable batteries 12 based on the consumed SOC calculated in step S3, the remaining amount of the replaceable batteries 12 possessed by the replacement battery station 2, and the remaining amount of the replaceable batteries 12 mounted on the vehicle 1 (step S4).

Subsequently, the battery control unit 134 controls the replaceable batteries 12 (step S5) so as to satisfy the replacement number and the target SOC determined in the step S5, and completes the present process.

In the controller of the replaceable batteries according to the embodiment described above, from the consumed SOC from the present position of the vehicle 1 to the replacement battery station 2, the remaining amount of the replaceable battery 12 of the replacement battery station 2, and the remaining amount of the replaceable battery 12 of the vehicle 1, to determine the replacement number and the target SOC of the replaceable battery 12. Then, so as to satisfy the determined replacement number and target SOC, by controlling the respective replaceable batteries 12, it is possible to ensure the required enough battery capacity in the entire vehicle 1.

According to the present disclosure, it is possible to secure the necessary and sufficient battery capacity for the entire vehicle.

Further effects and variations can be readily derived by one skilled in the art. Thus, the broader aspects of the invention are not limited to the specific details and representative embodiments represented and described above. Accordingly, various changes may be made without departing from the spirit or scope of the overall inventive concept defined by the appended claims and their equivalents.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A controller for a plurality of replaceable batteries comprising a controller for varying an overall battery capacity by connecting the exchangeable batteries in parallel in a vehicle mounting the exchangeable batteries, wherein
the controller is configured to
acquire, from a replacement battery station, information including at least remaining amounts of the replaceable batteries that the replacement battery station has,
calculate consumed SOC when the vehicle travels from a current position of the vehicle to the replacement battery station based on the current position of the vehicle and a position of the replacement battery station,
determine a replacement number and a target SOC of the replaceable batteries based on the calculated consumed SOC, remaining amounts of the replaceable batteries in the replacement battery station, and remaining amounts of the replaceable batteries mounted on the vehicle, and
control the replaceable batteries to satisfy the determined replacement number and the target SOC.
